(19) United States
(12) Patent Application Publication
(10) Pub. No.: US 2025/0218417 A1
(43) Pub. Date: Jul. 3, 2025

(54) DRUMHEAD ASSEMBLY

(71) Applicant: WEI-BO ZHOU, Taichung City (TW)

(72) Inventor: WEI-BO ZHOU, Taichung City (TW)

(21) Appl. No.: 18/399,962

(22) Filed: Dec. 29, 2023

(51) Int. Cl. G10D 13/20; G10D 13/02; G10D 13/24

(52) U.S. Cl. CPC G10D 13/20; G10D 13/02; G10D 13/24

(57) ABSTRACT

A drumhead assembly is provided, including: a drumhead and a ring member. The drumhead is made of a mesh material and has a striking surface. The ring member is disposed on a side of the drumhead opposite to the striking surface, and the ring member is made of an incompressible plastic material. Therefore, the drumhead assembly of the present invention provides realistic drumming feel and sound performance close to those of a conventional drumhead, which overcomes the problems of poor drumming feel, distortion in timbre and pitch performances, and poor structural strength of a conventional silent drumhead.

### BACKGROUND OF THE INVENTION

### Field of the Invention

The present invention relates to a drumhead assembly.

### Description of the Prior Art

Generally, drumheads of a drum kit are made of polyester film or PET material. Recently, a silent drumhead has been developed to reduce the sound level when being struct, which is convenient for a user to practice at home or in a small space. However, the conventional silent drumhead is made of a soft mesh material so that the sound produced by the conventional silent drumhead lacks fidelity, and the feel of striking the silent drumhead is also different from that of the conventional drumhead. In addition, the conventional silent drumhead has poor structural strength, which provides poor durability.

The present invention is, therefore, arisen to obviate or at least mitigate the above-mentioned disadvantages.

### SUMMARY OF THE INVENTION

The main object of the present invention is to provide a drumhead assembly, which can effectively reduce the sound level when being struck and provide a realistic drumming feel and good timbre performance.

To achieve the above and other objects, the present invention provides a drumhead assembly, including: a drumhead and a ring member. The drumhead is made of a mesh material and has a striking surface. The ring member is disposed on a side of the drumhead opposite to the striking surface, and the ring member is made of an incompressible plastic material.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a drawing showing the use of a preferable embodiment of the present invention;

FIG. 3 is a partial breakdown drawing of FIG. 2; and

FIG. 4 is a cross sectional view according to a preferable embodiment of the present invention in use.

### DETAILED DESCRIPTION OF THE PREFERRED EMBODIMENTS

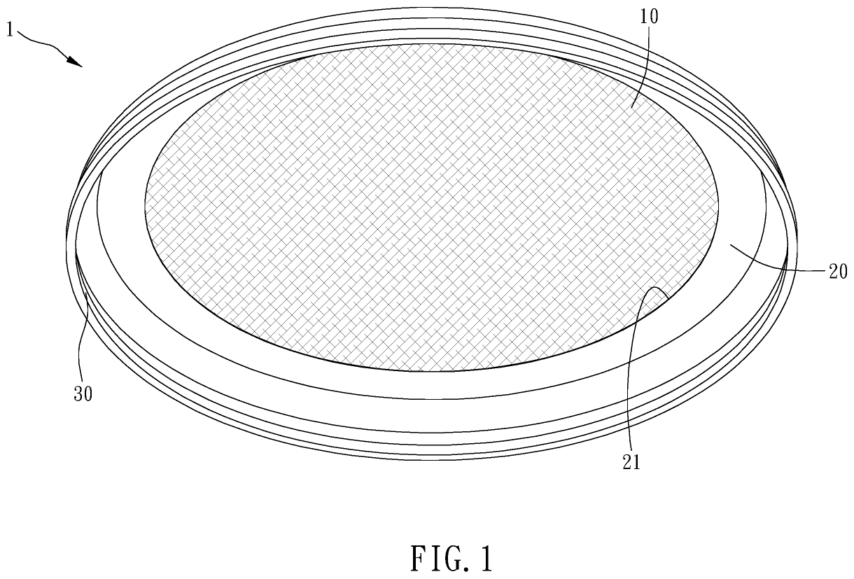

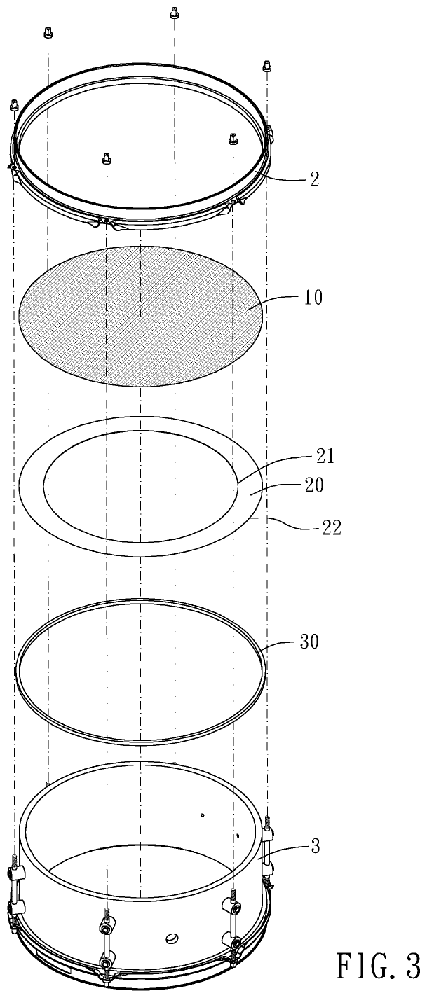

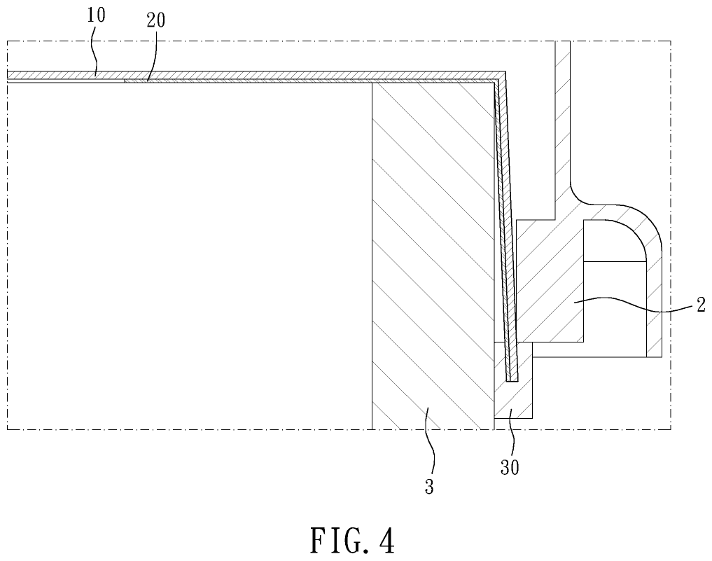

Please refer to FIGS. 1 to 4 for a preferable embodiment of the present invention. A drumhead assembly 1 of the present invention includes a drumhead 10 and a ring member 20.

The drumhead 10 is made of a mesh material and has a striking surface 11. The ring member 20 is disposed on a side of the drumhead 10 opposite to the striking surface 11, and the ring member 20 is made of an incompressible plastic material. With the ring member 20, the drumhead 10 provides a drumming feel close to a conventional drumhead (such as a drumhead made of PET), and provides a lower sound level and good timbre or pitch performance when being struck.

Specifically, the incompressible plastic material includes polyethylene terephthalate (PET), and the ring member 20 is a thin sheet. The ring member 20 includes an inner annular edge 21 and an outer annular edge 22 which are concentric with each other, and a difference of a radius of the inner annular edge 21 and a radius of the outer annular edge 22 is larger than or equal to 2 cm and smaller than or equal to 5 cm so as to effectively increase the structural strength of the drumhead assembly 1 and provide a different resonance effect compare to a conventional silent drumhead. Therefore, the drumhead assembly 1 provides concentrated sounds and good pitch performance. Preferably, the difference of the radius of the inner annular edge 21 and the radius of the outer annular edge 22 is between ⅙ and 1/9 of a radius of the drumhead 10. For example, if a size of the drumhead 10 is 14 inches, the difference of the radius of the inner annular edge 21 and the radius of the outer annular edge 22 may be 3 cm, which can reduce the sound level of the drumhead 10 and provide good drumming feel and sound performance when the drumhead 10 is struck.

A thickness of the drumhead 10 is larger than a thickness of the ring member 20, the thickness of the drumhead 10 is between 0.3 mm and 0.5 mm, and a mesh size of the drumhead 10 is between 40T and 60T so that the drumhead 10 is thick enough to provide good sound performance and not easy to be damaged. The thickness of the ring member 20 is between 0.1 mm and 0.3 mm (preferably is between 0.15 mm and 0.2 mm), and a difference of the thickness of the drumhead 10 and the thickness of the ring member 20 is larger than or equal to 0.2 mm. In this embodiment, the thickness of the drumhead 10 is 0.4 mm, the mesh size of the drumhead 10 is 50T (which means there are 50 meshes per linear centimeter), and the thickness of the ring member 20 is 0.188 mm, which is changeable to meet different requirements.

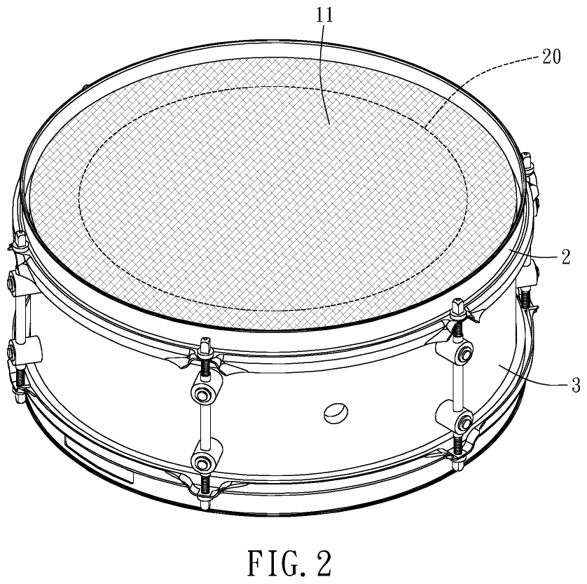

The drumhead assembly 1 further includes a frame member 30 being annular, and the frame member 30 is disposed around the drumhead 10 and the ring member 20 and integrally connects the drumhead 10 with the ring member 20. The frame member 30 is configured to be abutted against a drum hoop 2 so as to stretch the drumhead 10, which has a simple structure and is easy to manufacture. The ring member 20 is in surface contact with the drumhead 10 and partially covers a plurality of meshes of the drumhead 10, and the ring member 20 is configured to be disposed between the drumhead 10 and a drum shell 3, as shown in FIGS. 2 to 4, so as to effectively prevent the drumhead 10 from being deformed or damaged locally due to uneven stretching. Therefore, the drumhead assembly 1 is durable to use and provides good resonance effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A drumhead assembly, including:
a drumhead, made of a mesh material and having a striking surface; and
a ring member, disposed on a side of the drumhead opposite to the striking surface, the ring member being made of an incompressible plastic material.

2. The drumhead assembly of claim 1, wherein the ring member is in surface contact with the drumhead and partially covers a plurality of meshes of the drumhead, and the ring member is configured to be disposed between the drumhead and a drum shell.

3. The drumhead assembly of claim 1, wherein the incompressible plastic material includes polyethylene terephthalate (PET).

4. The drumhead assembly of claim 1, wherein a thickness of the ring member is between 0.1 mm and 0.3 mm.

5. The drumhead assembly of claim 1, wherein the ring member includes an inner annular edge and an outer annular edge which are concentric with each other, and a difference of a radius of the inner annular edge and a radius of the outer annular edge is larger than or equal to 2 cm.

6. The drumhead assembly of claim 1, wherein the ring member includes an inner annular edge and an outer annular edge which are concentric with each other, and a difference of a radius of the inner annular edge and a radius of the outer annular edge is between ⅙ and 1/9 of a radius of the drumhead.

7. The drumhead assembly of claim 1, wherein a thickness of the drumhead is larger than a thickness of the ring member.

8. The drumhead assembly of claim 1, wherein a thickness of the drumhead is between 0.3 mm and 0.5 mm, and a mesh size of the drumhead is between 40T and 60T.

9. The drumhead assembly of claim 1, further including a frame member being annular, wherein the frame member is disposed around the drumhead and the ring member and integrally connects the drumhead with the ring member.

10. The drumhead assembly of claim 2, wherein the incompressible plastic material includes polyethylene terephthalate (PET); the ring member is a thin sheet; a thickness of the ring member is between 0.15 mm and 0.2 mm; the ring member includes an inner annular edge and an outer annular edge which are concentric with each other, and a difference of a radius of the inner annular edge and a radius of the outer annular edge is larger than or equal to 2 cm and smaller than or equal to 5 cm; the difference of the radius of the inner annular edge and the radius of the outer annular edge is between ⅙ and 1/9 of a radius of the drumhead; a thickness of the drumhead is larger than the thickness of the ring member; the thickness of the drumhead is between 0.3 mm and 0.5 mm, and a mesh size of the drumhead is between 40T and 60T; a difference of the thickness of the drumhead and the thickness of the ring member is larger than or equal to 0.2 mm; and the drumhead assembly further includes a frame member being annular, and the frame member is disposed around the drumhead and the ring member and integrally connects the drumhead with the ring member.
